(19) United States
(12) Patent Application Publication
(10) Pub. No.: US 2012/0139270 A1
(43) Pub. Date: Jun. 7, 2012

(54) ENCLOSURE LOCK

(76) Inventor: Frank L. Gentile, Seymour, CT (US)

(21) Appl. No.: 13/290,747

(22) Filed: Nov. 7, 2011

Related U.S. Application Data
(60) Provisional application No. 61/420,521, filed on Dec. 7, 2010.

(51) Int. Cl. E05C 19/00; F16M 13/02

(52) U.S. Cl. 292/259 R; 248/224.8; 248/222.14

(57) ABSTRACT

Aspects of an enclosure lock are disclosed, including a mount that is coupleable to an enclosure and a bracket that may be selectively interlocked with the mount. The bracket may be secured along the mount to provide adjustability given various application-specific considerations and inhibit unauthorized access into the enclosure.

### CROSS REFERENCE TO RELATED APPLICATION

This application claims priority to U.S. provisional application 61/420,521 filed Dec. 7, 2010, which is hereby incorporated by reference as if fully set forth herein.

### STATEMENT REGARDING FEDERALLY SPONSORED RESEARCH

Not applicable.

### BACKGROUND

The present disclosure relates generally to an enclosure lock. More particularly, the disclosure describes an enclosure lock including a bracket that interlocks with a mount, which may be coupled to an enclosure, such that the bracket may be selectively positioned along the mount and adjacent to the enclosure.

Many types of enclosures benefit from restricted access to that which is housed within the enclosure. Access into the enclosure is often restricted to inhibit environmental debris (e.g., dust, water, and other contaminants) from fouling the components housed within the enclosure and/or to prohibit nefarious characters from tampering with the contents of the enclosure. For example, utilities, such as gas, electric, cable, and telecommunications, are often housed in an enclosure to hinder and deter tampering with and/or theft of the provided utility.

The form factor of the enclosure may vary depending upon the requirements of the particular application. In the utility context, for instance, the enclosure may be of any size and may be configured to accommodate a variety of components that extend through portions of the enclosure. For example, modular gang meter enclosures, which are commonly installed at apartment complexes, include multiple positions that may receive either a meter and cover plate or a blank plate where no meter is seated. The cover plate(s) and/or blank plate(s) are typically coupled to the balance of the enclosure by fasteners. However, fasteners (even tamper-resistant fasteners) provide limited impediment to undesired removal of the plates and thus access to the interior of the enclosure.

Several attempts have been made to enhance the security of these modular gang meter enclosures and other types/styles of enclosures. One approach involves securing each enclosure opening individually, such as by providing individual locks (e.g., a barrel lock assembly or padlock) to inhibit removal of each respective access panel (e.g., cover plate, blank plate, hinged door, etc.). This approach, however, is costly to implement and tedious to operate. Another approach involves use of a bar extending across the access panel(s) and secured to the enclosure at ends of the bar. However, the placement of the bar across the enclosure is restricted by the positioning of meters and other contours of the enclosure, potentially preventing this configuration from being installed in the most effective deterrent location.

In light of at least the above considerations, a need exists for an enclosure lock capable of engaging and locking enclosures of various application-specific form factors in an economical and efficient manner.

### SUMMARY

Aspects of an enclosure lock are disclosed, including a mount that is coupleable to an enclosure and a bracket that may be selectively interlocked with the mount. The bracket may be secured along the mount to provide adjustability given various application-specific considerations.

In one aspect, an enclosure lock comprises a mount coupleable to an enclosure, a first interlock fixed relative to the mount, a bracket coupleable to the mount, and a second interlock fixed relative to the bracket. The first interlock and the second interlock are selectively engageable such that the bracket may be secured to the mount adjacent to the enclosure.

In another aspect, an enclosure lock comprises a mount coupleable to an enclosure and defining a first interlock, and a bracket slideably captured to the mount and defining a second interlock. The first interlock and the second interlock are selectively engageable such that the bracket may be secured to the mount adjacent to the enclosure.

In a further aspect, a bracket configured to engage a mount coupleable to an enclosure includes a base defining a passage configured to slideably receive the mount, thereby capturing the bracket to the mount between ends of the mount. A cavity is formed in the base and extends into the passage. An interlock is within the cavity and is movable toward the passage. The interlock is configured to engage the mount to selectively couple the bracket to the mount.

The above and other aspects of the disclosure will be apparent from the description that follows. In the detailed description, preferred example embodiments will be described with reference to the accompanying drawings. These embodiments do not represent the full scope of the invention; rather, the invention may be employed in many other embodiments. Reference should therefore be made to the claims for determining the full breadth of the invention.

### BRIEF DESCRIPTION OF THE DRAWINGS

FIG. 1 is an isometric view of an example embodiment of an enclosure lock engaged with an example enclosure.

FIG. 2 is a isometric, detail view of the example enclosure lock assembly and enclosure circumscribed by arc 2-2 as shown in FIG. 1.

FIG. 3 is an isometric view of the example enclosure lock shown in FIG. 1.

FIG. 4 is an isometric view of the example mount.

FIG. 5A is an isometric view of a first example bracket.

FIG. 5B is an isometric view of the first example bracket shown in FIG. 5A.

FIG. 6A is an isometric view of a second example bracket.

FIG. 6B is an isometric view of the second example bracket shown in FIG. 6A.

FIG. 7A is an isometric view of a third example bracket.

FIG. 7B is an exploded, isometric view of the third example bracket shown in FIG. 7A.

FIG. 8 is a section view along line 8-8 of FIG. 3 illustrating the example enclosure lock in an engaged position.

FIG. 9 is a section view similar to FIG. 8 illustrating the example enclosure lock in a disengaged position.

FIG. 10 is an isometric, detail view of one end of the example enclosure lock circumscribed by arc 10-10 as shown in FIG. 3.

FIG. 11 is an isometric, detail view of another end of the example enclosure lock circumscribed by arc 11-11 as shown in FIG. 3.

FIG. 12 is an isometric view of another alternative example bracket.

FIG. 13 is a partial section view of another alternative example enclosure lock.

### DETAILED DESCRIPTION OF THE PREFERRED EXAMPLE EMBODIMENT

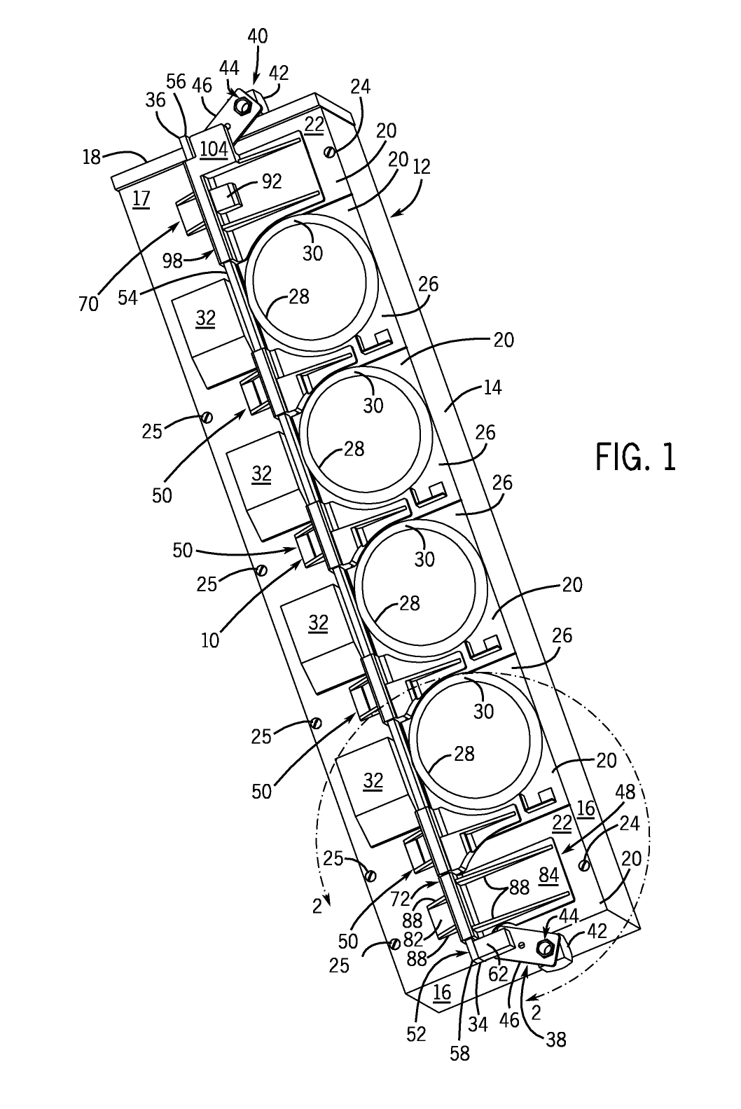

An example enclosure lock (10) (“lock (10)”) is illustrated in FIG. 1 and is shown mounted to an example enclosure (12). For example descriptive purposes only, the enclosure (12) is in the form of a modular gang meter box that includes a generally rectangular body (14) formed by a plurality of walls (16) and an end cap (18). The example enclosure (12) defines several positions (20) into which one or more devices (e.g., meters) may be conventionally seated and installed.

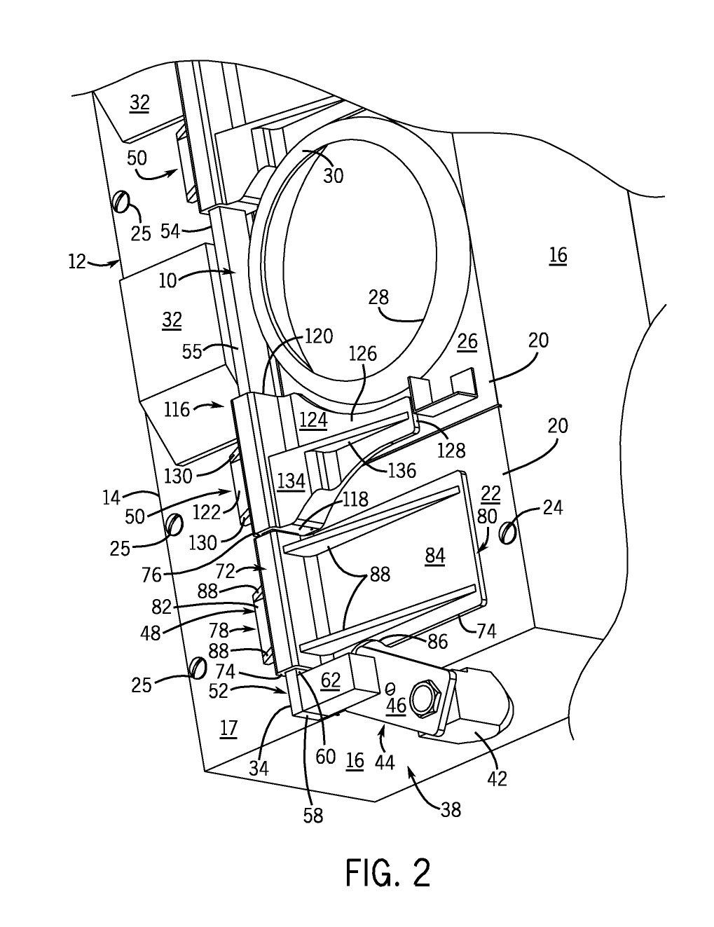

As illustrated in FIGS. 1 and 2, the enclosure (12) includes two types of example panels depending upon the particular application. For instance, where no device is located, the example enclosure (12) includes blank plates (22) coupled to body (14) via fasteners (24). The blank plates (22) are generally rectangular plates that inhibit access into the enclosure (12). Alternatively, where a device has (or will be) installed, cover plates (26) are coupled to the body (14) via additional fasteners (not shown). The cover plates (26) include an opening (28) through which a portion of a device (e.g., meter) can extend as desired. The cover plates (26) of the example embodiment define an annular rim (30) helping to restrain the installed device within the enclosure (12). As understood by one skilled in the art, another panel (17) is secured to the body (14) via fasteners (25) and may support a control cover (32) beneath which a control (e.g., a breaker switch) is located. Furthermore, different applications may result in various arrangements and configurations of the enclosure (12), panels (e.g., blank plate (22), cover plate (26), etc.), and controls (e.g., control cover (32), etc.).

The lock (10) is shown mounted to the enclosure (12) in FIGS. 1 and 2. Specifically, in the example embodiment, ends (34, 36) of the lock (10) are coupled to respective lock supports (38, 40). Each lock support (38, 40) includes an outer body (42) that is secured to either the end cap (18) or the wall (16) via respective fasteners (not shown). Each fastener extends partially through an opening in the end cap (18) and wall (16), respectively, and is secured to the outer body (42), such as by engaging a threaded bore (43) formed in the outer body (42). An inner body (44) is then seated into a central bore (not shown) in the outer body (42) and captured in the central bore by a barrel lock, as is understood by one skilled in the art. A tab (46) is secured (e.g., welded) to an end of the inner body (44) and extends there from to provide an attachment to the lock (10). The ends (34, 36) of the lock (10) are secured to the respective lock support (38, 40) prior to the inner bodies (44) being seated into the outer bodies (42), as is further described below. One skilled in the art will appreciate the options available to secure the ends (34, 36) of the lock (10) to the enclosure (12).

Before the lock (10) is mounted to the enclosure (12) via the lock supports (38, 40), application-specific brackets are coupled to and positioned along a mount (52). With specific reference to FIGS. 1-3, the example embodiment of the lock (10) includes three types of brackets in the form of a blank bracket (48), a cover bracket (50), and an end bracket (70). The example blank bracket (48) is configured to engage a portion of the blank plate (22), and, similarly, the example cover bracket (50) is configured to engage a portion of the cover plate (26) and the adjacent plate, whether a blank plate (22) or a cover plate (26). When the lock (10) is mounted to the enclosure (12), the blank bracket (48) and the cover bracket (50) inhibit the removal of the adjacent blank plate(s) (22) and cover plate(s) (26), respectively. The end bracket (70) is positioned near the end (36) of the lock (10) and engages the lock support (40) to secure the end (36) of the lock (10) to the enclosure (12) and to inhibit removal of an adjacent blank plate (22) and cover plate (26).

In the example lock (10), the blank bracket (48), the cover bracket (50), and the end bracket (70) are slideably captured to the mount (52) such that each can be positioned at various locations between the ends (34, 36) of the lock (10). The cover brackets (50) and the end bracket (70) are configured to interlock with the mount (52), thereby selectively fixing the position of each relative to the mount (52). The example blank bracket (48) is located between a fixed end (34) of the mount (52) and a secured cover bracket (50); however, the blank bracket (48) may also include an interlock in accordance with the interlock concept described herein.

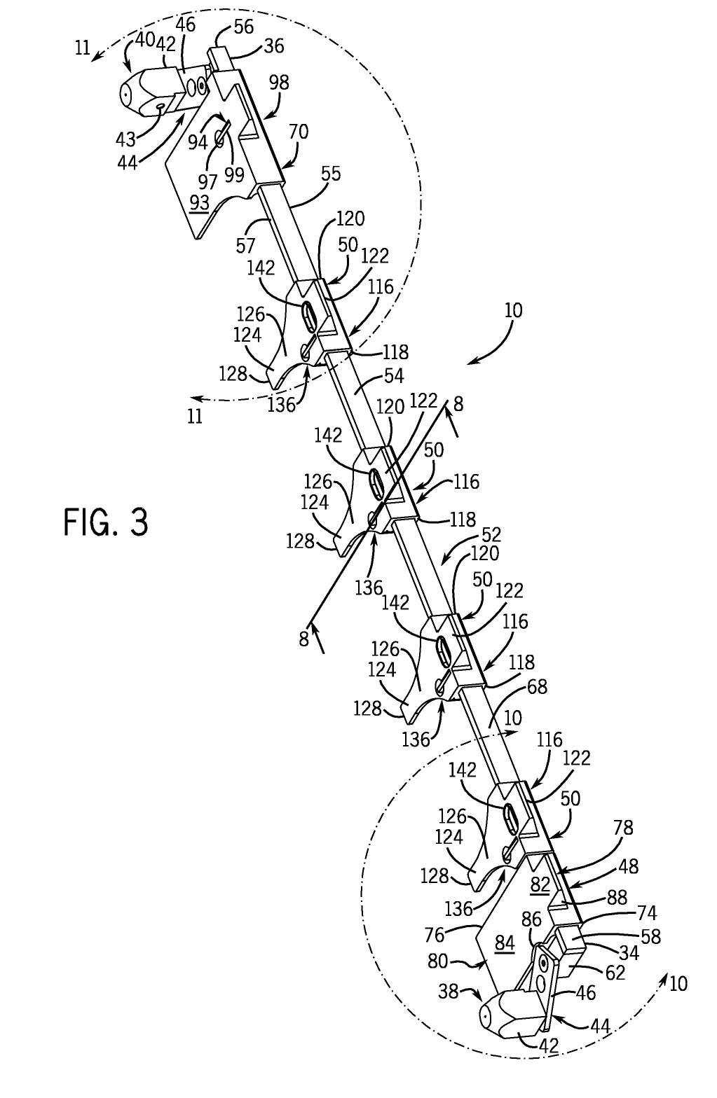

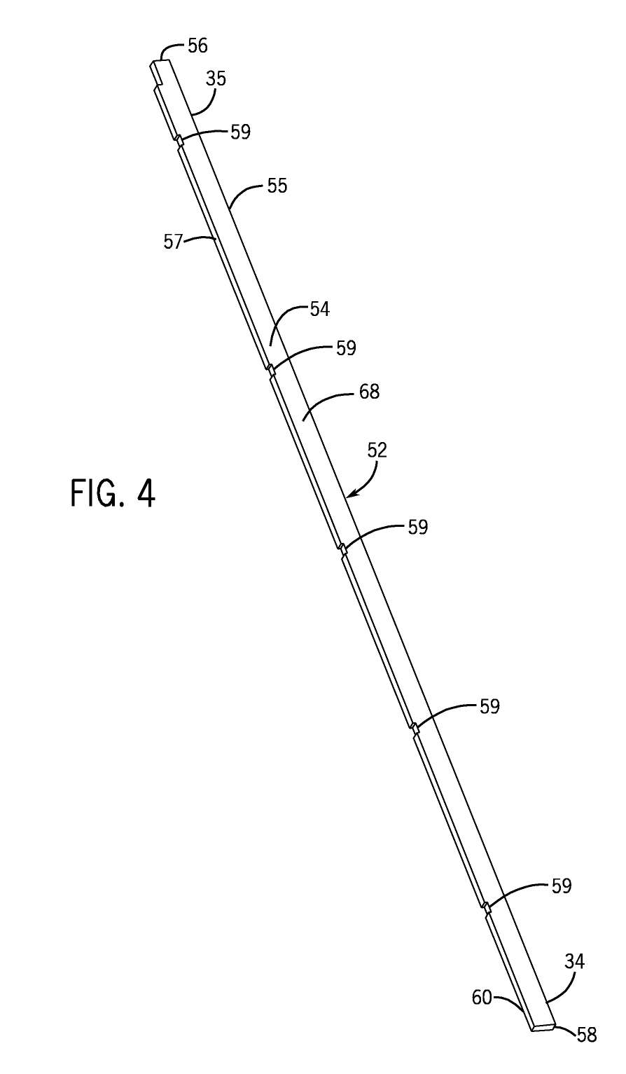

The example mount (52) and first interlock are illustrated in more detail in FIGS. 3 and 4. The mount (52) generally includes an elongated, rectangular bar (54) and a block (62). In the example embodiment, one end (56) of the bar (54) is notched to accommodate the end cap (18) of the enclosure (12). An opposite end (58) of the bar (54) defines a mounting surface (60) to which the block (62) is secured (e.g., welded). The block (62) extends away from the end (58) of the bar (54) and ultimately is coupled to one of the lock supports (38), as will be described below.

Returning to the mount (52), the bar (54) includes a first face (55) that is generally smooth and an opposite second face (57) that defines the first interlock. As shown, the example first interlock is illustrated in the form of a notch (59) defined in the second face (57). Several notches (59) extend along the bar (54) and, in the example embodiment, are placed in application-specific locations to accommodate the particular enclosure (12) configuration. The first interlock may have a variety of other forms, such as a series of equally spaced teeth having a squared-off profile (as viewed perpendicular to a side face (68) of the bar (54)) and defining a series of adjacent projections and recesses along substantially the entire length of the bar (54). Given the benefit of this disclosure, one skilled in the art will appreciate that the first interlock, may be regularly spaced or irregularly spaced, and may define a variety or combination of profiles (e.g., beveled, ramped, angled, saw tooth, sinusoidal, arcuate, etc.). A multi-tooth configuration will allow the brackets to be adjustable along a length of the mount (52), thus establishing a generally adjustable/universal interlock arrangement. Additionally, while the first interlock is shown as being integral with the mount (52), the interlock may be a separate component that is fixedly attached to the mount (52) such that the mount (52) and first interlock move substantially in unison. The bar (54) may also have other forms, such as defining a circular cross section, a half-circle cross section, a square cross section, a hexagonal cross section, a tubular cross section, and the like.

In the example embodiment, the cover brackets (50) and the end bracket (70) include a second interlock that engages with the first interlock (i.e., the notch (59)) to secure each bracket to the mount (52). Of course, as with the first interlock, while the second interlocks are described as being integral with the brackets, the second interlock may be a separate component that is fixed or secured to the respective bracket. Each bracket is generally described below; however, the structure and operation of the second interlock is described only in reference to the cover bracket (50), with the understanding that the end bracket (70) is substantially similar.

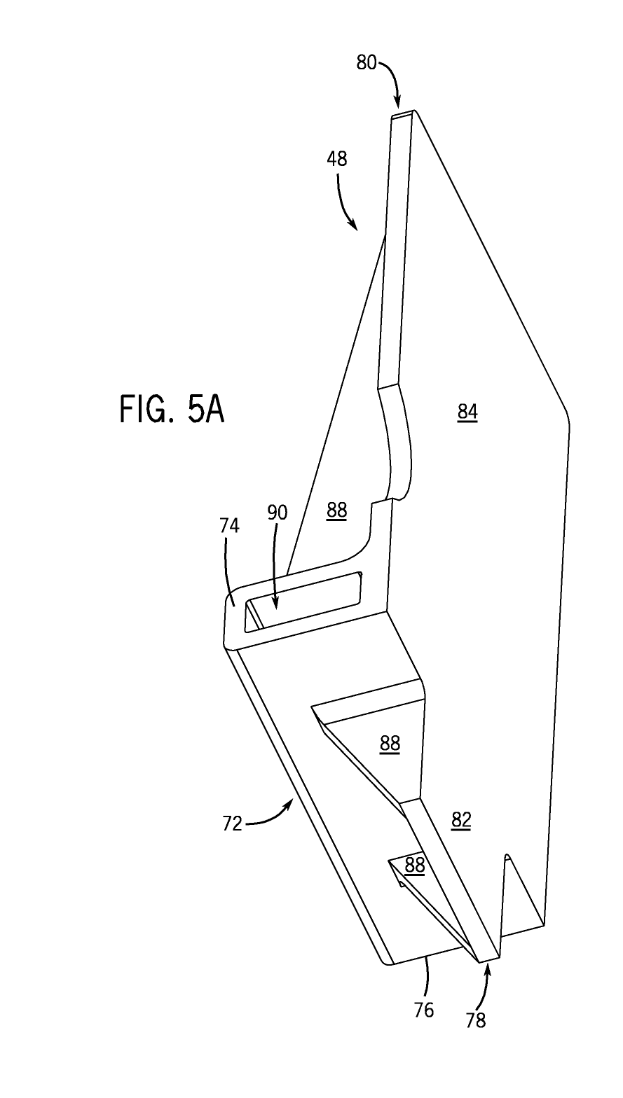

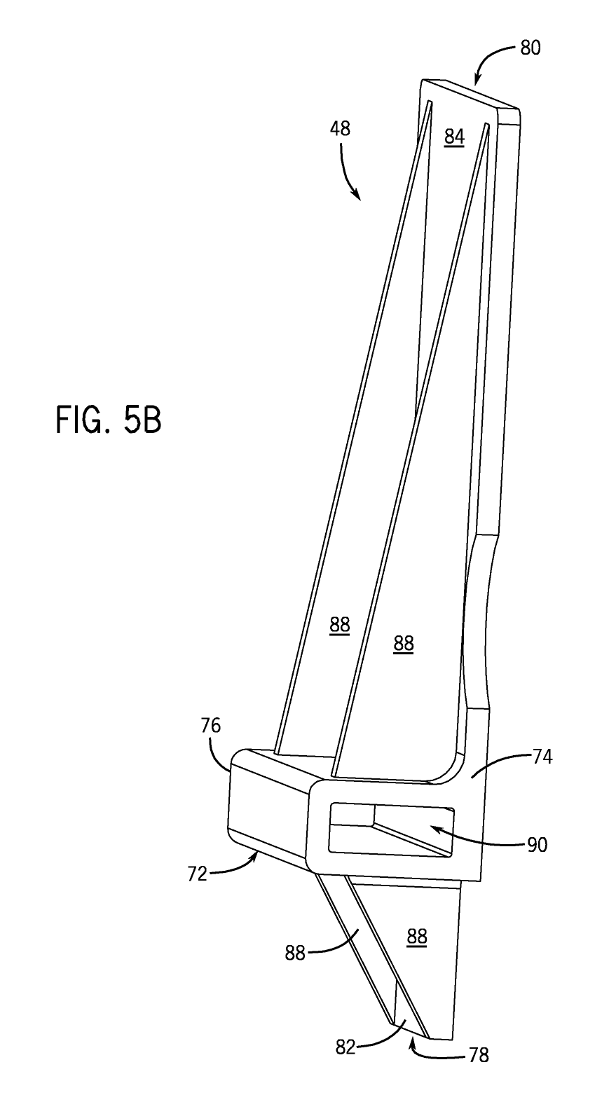

The example blank bracket (48) is illustrated in greater detail in FIGS. 5A and 5B. The blank bracket (48) includes a base (72) extending between sides (74, 76) of the blank bracket (48). A first projection (78) extends from the base (72) in a first direction that is substantially perpendicular to the bar (54). A second projection (80) extends from the base (72) in an opposite direction that too is substantially perpendicular to the bar (54). In other forms, the projections (78, 80) may extend from the base (72) at an orientation that is skewed relative to the bar (54) to accommodate the specific enclosure (12) construction. The first projection (78) and the second projection (80) (collectively, “projections (78, 80)”) are configured to be substantially coplanar such that the projections (78, 80) are substantially parallel to the blank plate (22) when the blank bracket (48) is installed and positioned adjacent to the enclosure (12) (see, e.g., FIG. 2).

The form factor and contour of each projection (78, 80) may be configured to accommodate the application-specific environment. For instance, the example first projection (78) defines a first rectangular plate (82) that is generally smaller than a second rectangular plate (84) defined by the second projection (80) because the entire lock (10) is offset from a centerline of the enclosure (12) (see, e.g., FIG. 1). Additionally, the second rectangular plate (84) defines an arcuate contour (86) along the side (74) to accommodate the tab (46) of the lock support (38). A series of ribs (88) are formed along the projections (78, 80) and increase the bending resistance of the respective rectangular plate (82, 84). In addition, the example projections (78, 80) extend across and cover at least a portion of the blank plate (22) and the panel (17) to inhibit undesired removal of each and prevent access into the enclosure (12).

A passage (90) extends through the base (72) between the sides (74, 76) of the blank bracket (48). The passage (90) allows the blank bracket (48) to be slideably captured to the bar (54), as shown in FIGS. 1, 2, 3, and 10, such that the bracket may be positioned at various locations along the bar (54) during use and removed from the bar (54) by sliding the blank bracket (48) over the end (36) of the mount (52). As one skilled in the art will appreciate, the passage (90) is configured to accept the form factor of the bar (54). In the example embodiment, the passage (90) has a generally rectangular cross section to accommodate the rectangular form factor of the bar (54). As noted above, the blank bracket (48) does not interlock with the mount (52), however, the interlocking engagement described below is equally applicable to the blank bracket (48), if desired.

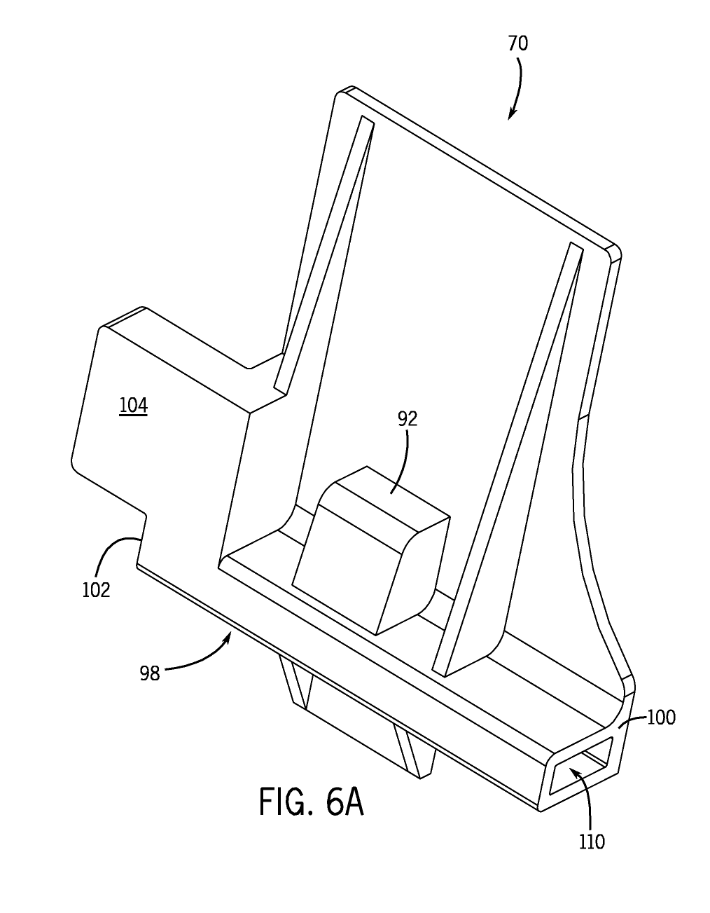

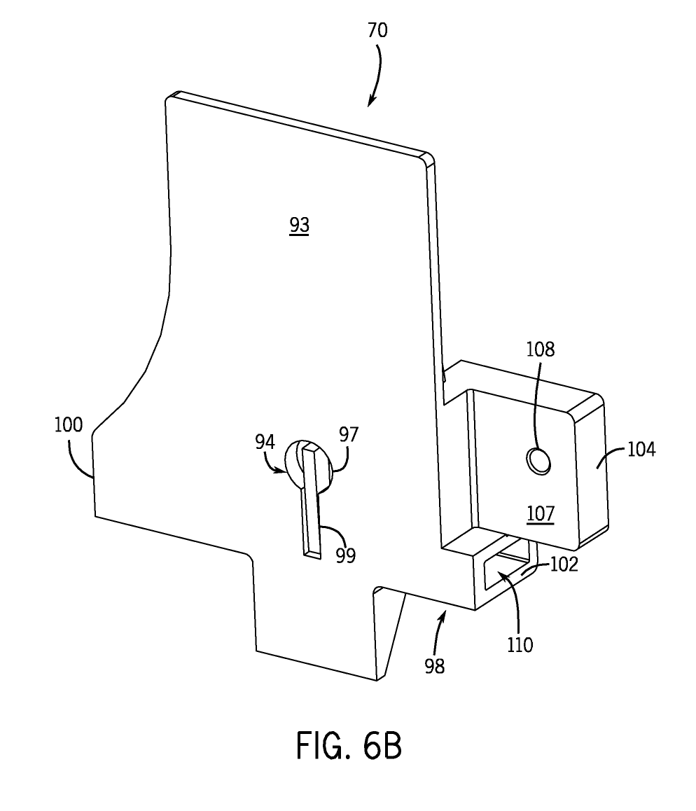

The example end bracket (70) is illustrated in greater detail in FIGS. 6A and 6B. The end bracket (70) is structurally similar to the blank bracket (48) described above and thus similar features will not be repeated. The end bracket (70) differs from the blank bracket (48) by the addition of an arm (104) and a boss (92) that extend from a base (98). Specifically, the arm (104) is generally L-shaped and extends substantially parallel to the base (98) in a direction defined between sides (100, 102). The arm (104) is illustrated as being integral with the base (98), however, the arm (104) may be a separate component coupled (e.g., fastened) to the base (98). The arm (104) defines a threaded hole (108) in a surface (107) (see, e.g., FIG. 6B) that is engaged by a fastener when the end bracket (70) is installed and engaged with the lock support (40). The form factor and contour of the end bracket (70) may be configured depending upon the application-specific environment.

A passage (110) extends through the base (98) between the sides (100, 102) of the end bracket (70). The passage (110) allows the end bracket (70) to be slideably captured to the mount (52), such that the bracket may be positioned at various locations along the bar (54) during use and removed from the bar (54) by sliding the end bracket (70) over the end (36) of the mount (52). As will be described in more detail below, the end bracket (70) of the example embodiment is located near the end (36) of the bar (54) such that it may be coupled to the lock support (40).

The boss (92) extends from the base (98) and houses a second interlock, as will be described with reference to the cover bracket (50). A cavity (94) is formed in a surface (93) of the base (98) and includes a circular portion (97) adjacent a rectangular portion (99). The cavity (94) extends into the passage (110) such that the second interlock seated in the cavity (94) can engage the first interlock (i.e., the notch (59)) to engage and couple the end bracket (70) to the mount (52).

In an alternative configuration, an end bracket may only include the base (98) and an arm (104) extending from the base (98). The base (98) is interlockable with the mount (52) and the arm (104) is coupleable to the lock support (40). In this arrangement, a blank bracket (48) may be installed adjacent the alternative end bracket to inhibit removal of the blank plate (22). One skilled in the art will appreciate other alternative configurations in view of this disclosure.

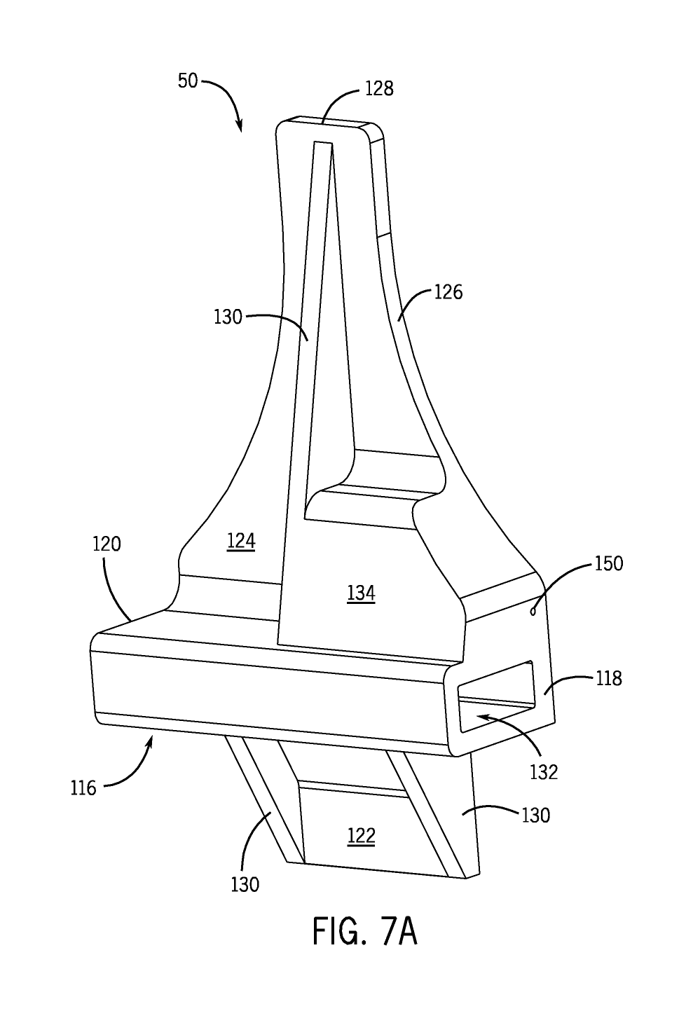

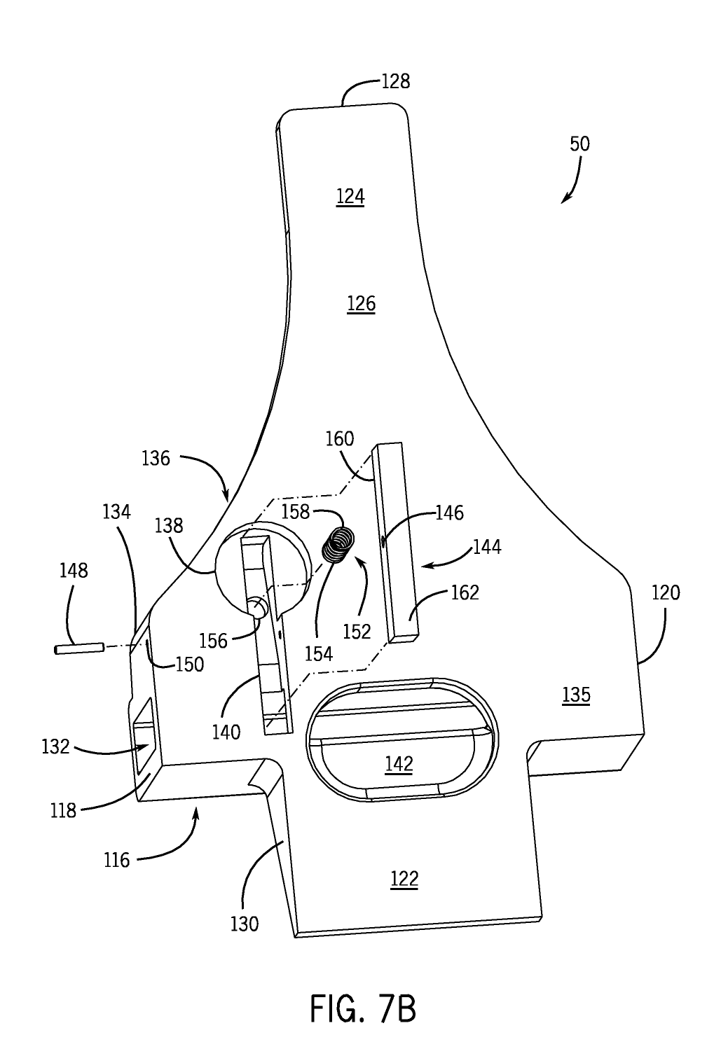

The example cover bracket (50) is illustrated in greater detail in FIGS. 7A and 7B. The cover bracket (50) includes a base (116) extending between sides (118, 120) of the cover bracket (50). A first projection (122) extends from the base (116) in a first direction and a second projection (124) extends from the base (116) in an opposite direction. The first projection (122) and the second projection (124) (collectively, “projections (122, 124)”) extend substantially perpendicular to the bar (54) and are configured to be generally coplanar such that the projections (122, 124) are substantially parallel to the cover plate(s) (26) when the cover bracket (50) is installed and positioned adjacent to the enclosure (12). As with the other brackets, the form factor and contour may be configured to accommodate the application-specific environment to at least partially cover and extend across the cover plates (26), thereby inhibiting unauthorized removal of the cover plates (26). For instance, the example second projection (124) defines a second rectangular plate (126) that tappers inward from the base (116) toward a distal end (128) to accommodate the openings (28) and annular rims (30) of adjacent cover plates (26). Again, a series of ribs (130) are formed along the projections (122, 124).

A passage (132) extends through the base (116) between the sides (118, 120) of the cover bracket (50). The passage (132) allows the cover bracket (50) to be slideably captured to the bar (54), such that the cover brackets (50) may be positioned at various locations along the bar (54) during use and removed from the bar (54) by sliding the cover bracket (50) over the end (36) of the mount (52). As one skilled in the art will appreciate, the passage (132) is again configured to accept the form factor of the bar (54).

A boss (134) extends from the base (116) and houses a second interlock (described below). A cavity (136) is formed in an engagement surface (135) of the base (116) and includes a circular portion (138) adjacent a rectangular portion (140). The cavity (136) extends into the passage (132) such that the second interlock seated in the cavity (136) can engage the first interlock (i.e., the notch (59)) to engage and couple the cover bracket (50) to the mount (52). The engagement surface (135) also includes a pocket (142) that is configured to cover one or more fasteners (25) when the engagement surface (135) is adjacent the panel (17), thus allowing the cover bracket (50) to sit substantially flush against the panel (17) and the cover plate (26) during use.

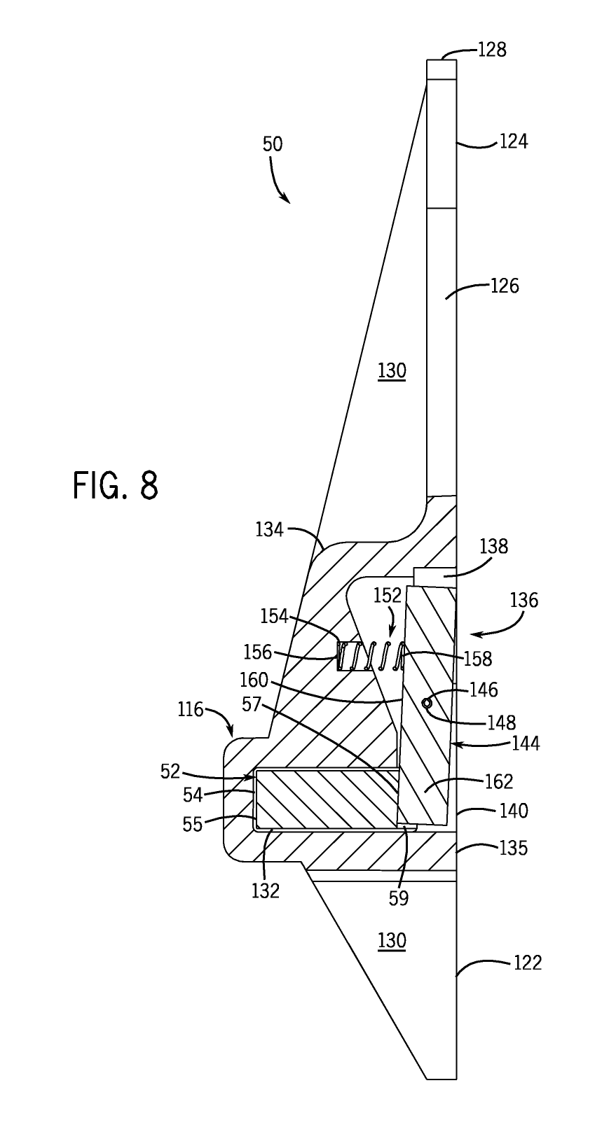

The engagement between the example first interlock and the example second interlock of the cover bracket (50) is described below with additional reference to FIGS. 7B, 8, and 9. As previously described, the example first interlock is in the form of a notch (59) formed in the bar (54). The example second interlock is in the form of a lever (144) pivotally coupled within the cavity (136) formed in the base (116) of the cover bracket (50). Specifically, the lever (144) is a generally rectangular bar having a bore (146) formed there through for receiving a spring pin (148). The spring pin (148) is inserted into the rectangular portion (140) of the cavity (136) through an opening (150) extending through the boss (134) (see, e.g., FIG. 7B) to secure and establish a pivot axis of the lever (144). A biasing member in the form of a compression spring (152) includes a first end (154) seated in a bore (156) formed in the circular portion (138) of the cavity (136), and includes a second end (158) that abuts a face (160) of the lever (144) when installed, such as shown in FIG. 8.

Given that the cavity (136) extends into the passage (132), a portion (162) of the lever (144) is biased toward the passage (132) by the compression spring (152) (shown in FIG. 8). As a result, the portion (162) of the lever (144) is biased into the notch (59) formed in the mount (52), thereby preventing relative movement between the cover bracket (50) and the mount (52). That is, the example first interlock and example second interlock are engaged. In the example embodiment, the width of the notch (59) is sized larger than the width of the lever (144) to provide an application-specific amount of tolerance at the engagement.

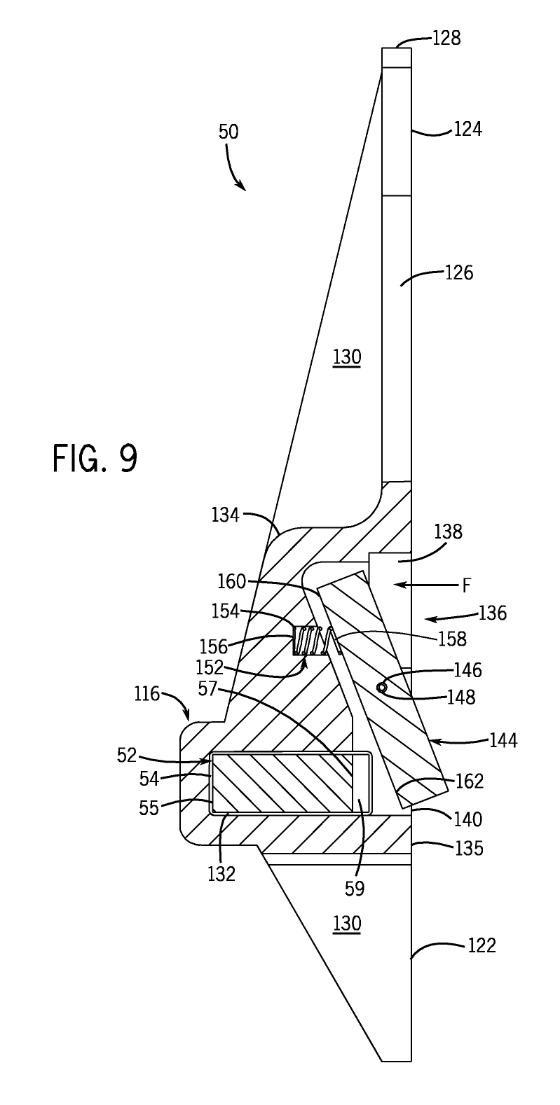

To move the second interlock into the disengaged position shown in FIG. 9, a force F is applied to pivot the lever (144) about the spring pin (148) against the bias of the compression spring (152). As a result, the portion (162) of the lever (144) is pivoted out of interference with the mount (52), allowing the cover bracket (50) to be slid along the bar (54).

As one skilled in the art will appreciate, given the benefit of this disclosure, various aspects of the second interlock may be altered. For instance, the lever (144) may be flared at an end, irregular in cross section, and the like. Moreover, the biasing member may be a leaf spring or any other type of resilient member capable of providing a biasing force. Additionally, while the components may be made from any material appropriate for a given application, where durability and strength are beneficial, the components may be made of heat treatable low carbon steel, such as AISI 1010, AISI 1018, and the like. Furthermore, some form of corrosion resistance (e.g., plating) may be applied if desired for a particular application.

The final assembly and installation of the example lock (10) to an enclosure (12) is shown in FIG. 1 and is described below with additional reference to FIGS. 2-11. To assemble the lock (10), the blank bracket (48) is slid onto the mount (52) by inserting the bar (54) into the passage (90). The blank bracket (48) is slid along the bar (54) to the end (34) where it abuts the block (62) that is secured to the bar (54). In the example embodiment, the blank bracket (48) does not include a second interlock (i.e., biased lever (144)) and is instead restrained by virtue of being seated between the block (62) and an adjacent cover bracket (50) that does interlock with the mount (52).

With the blank bracket (48) installed to the mount (52), each cover bracket (50) is slid along the bar (54) to a desired interlock location by first moving the example second interlock into the disengaged position by biasing the lever (144) against the compression spring (152), thereby moving the lever (144) out of the passage (132). Removing the force F from the lever (144) will allow the compression spring (152) to bias the lever (144) into engagement with the respective notch (59) in the mount (52), interlocking the first interlock (i.e., the notch (59)) of the mount (52) with the second interlock (i.e., the lever (144)) of the cover bracket (50). In other forms, the mount (52) may include ramped projections such that the force used to slide the cover bracket (50) along the mount (52) also biases the lever (144) toward and into the disengaged position, such that the lever (144) ratchets against the successive ramped projections.

With the cover brackets (50) interlocked with the mount (52), the second interlock of the end bracket (70) may similarly be disengaged such that the bar (54) is inserted into the passage (110). The end bracket (70) is positioned proximate the end (36) of the mount (52) to enable the lock support (40) to be secured thereto.

While the above “passages” are illustrated as fully surrounding the bar (54), alternative passages may be incorporated that do not fully surround the bar (54) in order to capture the bracket to the mount (52). For instance, a U-shaped passage in which a second interlock closes off at least a portion of the open end of the “U” is one alternative configuration. One skilled in the art, given the benefit of this disclosure, will appreciate the variations available.

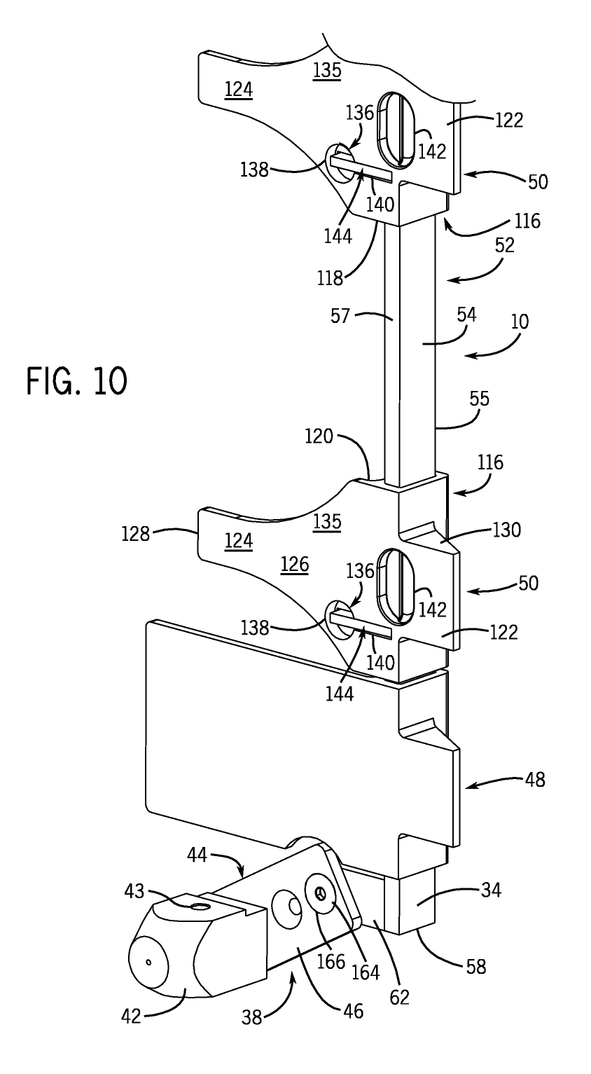

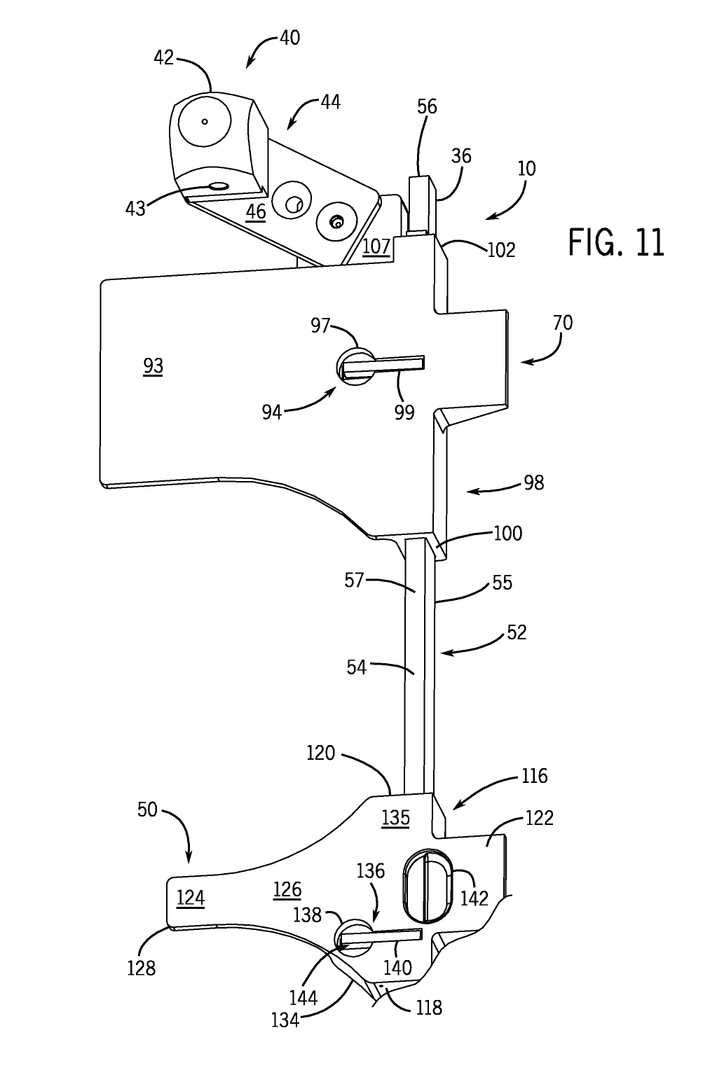

When the lock (10) is fully assembled, the block (62) near the end (34) and the arm (104) near the end (36) are coupled to the tabs (46) of respective lock supports (38, 40). A fastener (164) extends partially through an opening (166) in the tab (46) to threadably engage the threaded hole in the block (62), thereby capturing the tab (46) of the lock support (38) to the block (62) (shown in FIG. 10). Similarly, a fastener (168) extends partially through an opening (170) in the tab (46) to threadably engage the threaded hole (108) in the arm (104), thereby capturing the tab (46) of the lock support (40) to the arm (104) (shown in FIG. 11). The inner bodies (44) are inserted into the respective outer bodies (42) and secured in a conventional manner (e.g., barrel locks). In one version, the inner bodies (44) are inhibited from rotating within the bores formed in the respective outer bodies (42). For example, similar to the adjustable hex housing incorporated into the Multi-Maxx™ Electric Meter Bar manufactured by Highfield Manufacturing Company of Bridgeport, Conn., the bore within the outer body (42) may be contoured to define a shaped cavity (e.g., triangular, square, hexagonal, etc.) that inhibits a mating inner body (44) (i.e., an inner body having a conforming form factor) from rotating within the shaped cavity.

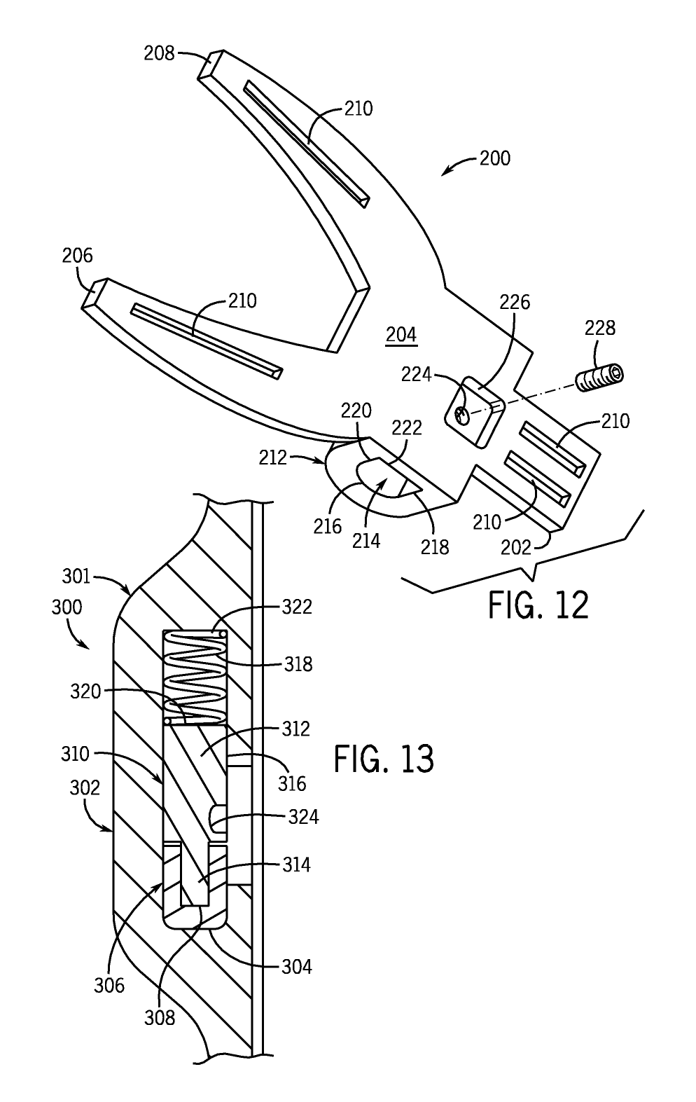

Given the benefit of this disclosure, one skilled in the art will appreciate the various available modifications to the interlock concept. For example, another example bracket (200) is illustrated in FIG. 12. The bracket (200) includes a first projection (202) similar to the above brackets. However, the second projection (204) includes two prongs (206, 208) forming a generally U-shaped structure that is configured to extend at least partially across and cover a plate or panel that is to be secured to an enclosure. In addition, the projections (202, 204) may include strengthening ribs (210) that are formed into each projection (202, 204), such as by deforming (e.g., stamping) the material of the projections (202, 204) into the form of a rib (210). A base (212) of the bracket (200) defines a passage (214) that, when viewed in cross section, includes an arcuate segment (216), a pair of straight sides (218, 220) at each end of the arcuate segment (216), and another straight segment (222) connecting the straight sides (218, 220). A mount (not shown) is then configured accordingly to slide within the passage (214). A second interlock is included and comprises a threaded bore (224) formed in a pocket (226) and a set screw (228) configured to engage the threaded bore (224). The threaded bore (224) extends into the passage (214) such that the set screw (228), when inserted, may engage a mating first interlock formed on the mount. The first interlock may include a series of dimples formed along the mount, spaced apart notches/bores, and the like.

With reference to FIG. 13, an alternative example enclosure lock (300) is illustrated in cross section. As shown, a bracket (301) includes a base (302) forming a passage (304) into which a mount (306) is slideably inserted. The mount (306) includes a first interlock in the form of a plurality of spaced apart pockets (308) sized to engage (e.g., receive) a second interlock in the form of a slider (310). Specifically, the slider (310) includes a body portion (312) and a head portion (314) that slide within a cavity (316) formed in the base (302). The head portion (314) is biased into a pocket (308) by a compression spring (318) seated between an end face (320) of the slider (310) and an end wall (322) of the cavity (316). A depression (324) is formed in body portion (312) such that a force may be applied to disengage the head portion (314) with the pocket (308). As one skilled in the art will appreciate, the cavity (316) is contoured to receive the slider (310) and allow for relative movement of the slider (310) within the cavity (316). For example, the body portion (312) may be rectangular in cross section and the head portion (314) may be circular in cross section. The cavity (316) and pockets (308) are then contoured accordingly. Additionally, the compression spring (318) may comprise a variety of biasing members, such as an extension spring, a leaf spring, a resilient block, and the like.

While there has been shown and described what is at present considered the preferred embodiments of the invention, it will be obvious to those skilled in the art that various additional changes and modifications can be made, given the benefit of this disclosure, without departing from the scope of the invention defined by the following claims.

We claim:

1. An enclosure lock, comprising:
a mount coupleable to an enclosure;
a first interlock fixed relative to the mount;
a bracket coupleable to the mount; and
a second interlock fixed relative to the bracket;
wherein the first interlock and the second interlock are selectively engageable such that the bracket may be secured to the mount adjacent to the enclosure.

2. The enclosure lock of claim 1, wherein the bracket is slideably captured to the mount.

3. The enclosure lock of claim 1, wherein:
the first interlock is integrally formed with the mount; and
the second interlock is integrally formed with the bracket.

4. The enclosure lock of claim 1, wherein the second interlock comprises a fastener engaged with the bracket.

5. The enclosure lock of claim 1, wherein the mount comprises at least one of a bar, a rod, and a tube.

6. The enclosure lock of claim 1, wherein the bracket comprises:
a base coupleable to the mount; and
a projection extending from the base that is contoured to extend substantially parallel to the enclosure.

7. The enclosure lock of claim 6, wherein the second interlock comprises a lever pivotally coupled to the base and biased into engagement with the first interlock.

8. The enclosure lock of claim 1, wherein a resilient member biases the first interlock and the second interlock into engagement.

9. The enclosure lock of claim 1, wherein the first interlock comprises multiple projections extending along at least a portion of the mount.

10. An enclosure lock, comprising:
a mount coupleable to an enclosure and defining a first interlock; and
a bracket slideably captured to the mount and defining a second interlock;
wherein the first interlock and the second interlock are selectively engageable such that the bracket may be secured to the mount adjacent to the enclosure.

11. The enclosure lock of claim 10, wherein the bracket defines a passage configured to receive the mount.

12. The enclosure lock of claim 10, wherein:
the first interlock is integrally formed with the mount; and
the second interlock is integrally formed with the bracket.

13. The enclosure lock of claim 10, wherein the second interlock comprises a fastener engaged with the bracket.

14. The enclosure lock of claim 10, wherein the mount comprises at least one of a bar, a rod, and a tube.

15. The enclosure lock of claim 10, wherein the bracket comprises:
a base coupleable to the mount; and
a projection extending from the base that is contoured to extend substantially parallel to the enclosure.

16. The enclosure lock of claim 15, wherein the second interlock comprises a lever pivotally coupled to the base and biased into engagement with the first interlock.

17. The enclosure lock of claim 10, wherein a resilient member biases the first interlock and the second interlock into engagement.

18. The enclosure lock of claim 10, wherein the first interlock comprises multiple projections extending along at least a portion of the mount.

19. A bracket configured to engage a mount coupleable to an enclosure, the bracket comprising:
a base defining a passage configured to slideably receive the mount thereby capturing the bracket to the mount between ends of the mount;
a cavity formed in the base and extending into the passage; and
an interlock within the cavity and movable toward the passage;
wherein the interlock is configured to engage the mount to selectively couple the bracket to the mount.

20. The bracket of claim 19, wherein the interlock further comprises:
a threaded bore in the cavity; and
a set screw configured to engage the threaded bore.
